(19) United States
(12) Patent Application Publication
(10) Pub. No.: US 2015/0319250 A1
(43) Pub. Date: Nov. 5, 2015

(54) TECHNOLOGIES FOR ACCELERATING NETWORK VIRTUALIZATION

(71) Applicants: Anil Vasudevan, Portland, OR (US); Parthasarathy Sarangam, Portland, OR (US); Rajesh M. Sankaran, Portland, OR (US)

(72) Inventors: Anil Vasudevan, Portland, OR (US); Parthasarathy Sarangam, Portland, OR (US); Rajesh M. Sankaran, Portland, OR (US)

(21) Appl. No.: 14/583,667

(22) Filed: Dec. 27, 2014

Related U.S. Application Data
(60) Provisional application No. 61/986,329, filed on Apr. 30, 2014.

(51) Int. Cl. H04L 29/08; H04L 12/24; H04L 12/46

(52) U.S. Cl. CPC H04L 67/141; H04L 12/4633; H04L 41/5054

(57) ABSTRACT

Technologies for accelerated network virtualization include executing packet processing functions by a network virtualizer established in a provider partition of a computing device and offloading packet movement functions to a network interface controller of the computing device. In the illustrative embodiments, the network interface controller includes one or more tenant-facing ports, a provider-facing port, and an external network-facing port, which are used by the network interface controller to receive, send, and pass packets from, to, and between the various partitions of the computing device. To transmit a packet, the network virtualizer generates a provider header, and either the network virtualizer or the network interface controller encapsulates a packet received from the tenant partition with the provider header. To receive a packet, either the network virtualizer or the network interface controller strips a provider header from the received packet.

### CROSS-REFERENCE TO RELATED APPLICATION

The present application claims priority under 35 U.S.C. §119(e) to U.S. Provisional Patent Application Ser. No. 61/986,329, entitled “TECHNOLOGIES FOR ACCELERATING NETWORK VIRTUALIZATION,” which was filed on Apr. 30, 2014.

### BACKGROUND

Network virtualization is a technology for establishing multiple “virtual” networks on the same “physical” network. Network virtualization is a key technology for cloud computing models, including Infrastructure as a Service (IaaS) models. Similar to other virtualization technologies, network virtualization provides a user (often referred to as a guest or tenant) with the experience of a private network, even though communications may be occurring across shared or public components.

Typical network virtualization technologies are implemented completely in software at an edge of the physical network (e.g., at the ingress or egress points of the physical network), which allow the virtual networks to be “physical network unaware.” Because typical network virtualization is implemented in software, the network virtualizer must emulate a significant amount of the traditional network interface controller (NIC) functionality including, for example, movement of data via direct memory access (DMA) and associated existing packet acceleration functions such as Large Segmentation Offload (LSO), Receive Side Scaling (RSS), and Receive Side Coalescing (RSC). In many implementations, such data movement and packet acceleration functions may be considered an inefficient use of the main processor's work cycles.

Although additional technologies have been developed to alleviate the inefficient use of processor time (e.g., Single Root I/O Virtualization (SR-IOV)), such technologies may create other challenges in a network virtualization environment. For example, SR-IOV technologies typically provide a direct path for a host (e.g., a virtual monitor) to transmit packets across the network, bypassing the network virtualizer altogether, which may be unacceptable for many Infrastructure as a Service (IaaS) implementations.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for accelerated network virtualization;

FIG. 2 is a simplified block diagram of at least one embodiment of a partition environment of a computing device of FIG. 1;

FIG. 3 is a simplified block diagram of at least one embodiment of an environment that may be established on the computing device of FIGS. 1 and 2;

FIG. 4 is a simplified block diagram of a networking stack that may be implemented by the computing device of FIGS. 1-3;

FIGS. 5 and 6 is a simplified flow diagram of at least one embodiment of a method for receiving packets that may be executed by the computing device of FIGS. 1-3; and

FIGS. 7 and 8 is a simplified flow diagram of at least one embodiment of a method for transmitting packets that may be executed by the computing device of FIGS. 1-3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

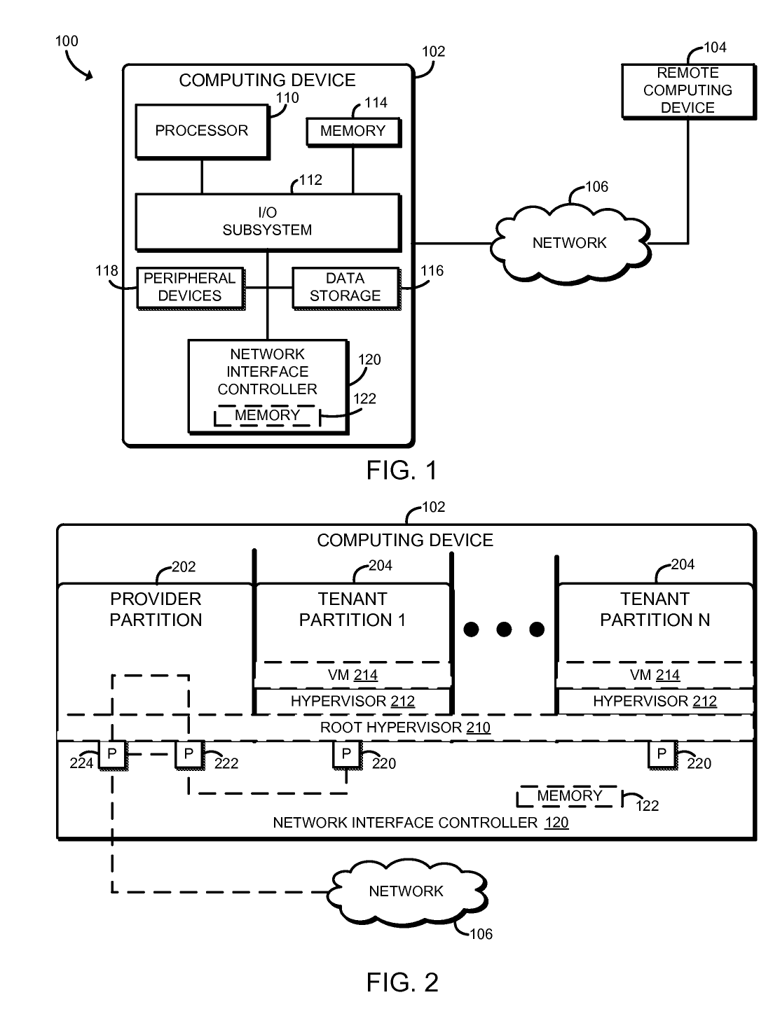

Referring now to FIG. 1, an illustrative system 100 for accelerated network virtualization includes a computing device 102, which communicates with a remote computing device 104 across a network 106. As discussed in more detail below, the computing device 102 implements network virtualization to allow one or more tenants (hosts) established in corresponding tenant partitions on the computing device 102 to experience a private network over the network 106. The network virtualization is accomplished by encapsulating packets generated by the hosts of the tenant partitions with a provider packet header. Additionally, the network virtualization of the computing device 102 is accelerated by assigning packet processing functions to a network virtualizer established in a provider partition and offloading packet movement functions and existing network interface controller acceleration/offload functions (e.g., LSO, RSS, RSC, etc.) to a network interface controller 120 of the computing device 102. To do so, the network interface controller 120 includes multiple ports to communicate with the tenant partitions and the provider partition to move packets to, from, and/or between the partitions. Network virtualization is provided by the network virtualizer, which generates and manages the provider packet headers used to encapsulate the tenant-originated packets. It should be appreciated that typical network interface controller acceleration functions are still available for the tenant facing ports because such ports function as a standard network interface controller port for packets without encapsulation.

As discussed in more detail below, to transmit a packet from the computing device 102, a host of a tenant partition generates a packet to be transmitted and passes the packet to the network interface controller 120 via a corresponding tenant-facing port. In some embodiments, the network interface controller 120 subsequently passes the packet to the network virtualizer via a provider-facing port, and the network virtualizer encapsulates the packet with the provider packet header. The network interface controller 120 subsequently transmits the encapsulated packet over the network 106 via a network-facing port. In other embodiments, the network interface controller 120 may receive the generated provider packet header from the network interface controller 120 via the provider-facing port and encapsulate the packet using the received provider packet header.

Conversely, to receive a packet from the network 106, the network interface controller 120 receives the packet from the network 106 via the network-facing port and, in some embodiments, passes the packet to the network virtualizer via the provider-facing port. In such embodiments, the network virtualizer processes the packet to strip the packet of any provider packet header and passes the stripped packet back to the network interface controller 120, which subsequently sends the stripped packet to the designated host of a tenant partition. In other embodiments, the network interface controller 120 may be configured to strip the provider packet header from the packet, pass the provider packet header (and a portion or all of the packet) to the network virtualizer for further processing or analysis, and pass the stripped packet to the designated host of a tenant partition.

The computing device 102 may be embodied as any type of computing device for communicating over the network 106 using network virtualization. For example, the computing device 102 may be embodied as a server, a server controller, a router, a switch, a networking device, a distributed computing system, a multiprocessor system, desktop computer, a consumer electronic device, a smart appliance, a laptop computer, a notebook computer, a tablet computer, a smart phone, a cellular phone, and/or any other computing device capable of network virtualization. As shown in FIG. 1, the illustrative computing device 102 includes a processor 110, an I/O subsystem 112, memory 114, a data storage 116, one or more peripheral devices 118, and a network interface controller 120. Of course, the computing device 102 may include other or additional components, such as those commonly found in a computer (e.g., various input/output devices), in other embodiments. Additionally, in some embodiments, one or more of the illustrative components may be incorporated in, or otherwise from a portion of, another component. For example, the memory 114, or portions thereof, may be incorporated in the processor 110 in some embodiments.

The processor 110 may be embodied as any type of processor capable of performing the functions described herein. For example, the processor may be embodied as a single or multi-core processor(s), digital signal processor, microcontroller, or other processor or processing/controlling circuit. Similarly, the memory 114 may be embodied as any type of volatile or non-volatile memory or data storage capable of performing the functions described herein. In operation, the memory 114 may store various data and software used during operation of the computing device 102 such as operating systems, applications, programs, libraries, and drivers. The memory 114 is communicatively coupled to the processor 110 via the I/O subsystem 112, which may be embodied as circuitry and/or components to facilitate input/output operations with the processor 110, the memory 114, and other components of the computing device 102. For example, the I/O subsystem 112 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 112 may form a portion of a system-on-a-chip (SoC) and be incorporated, along with the processor 110, the memory 114, and other components of the computing device 102, on a single integrated circuit chip.

The data storage 116 may be embodied as any type of device or devices configured for short-term or long-term storage of data such as, for example, memory devices and circuits, memory cards, hard disk drives, solid-state drives, or other data storage devices. The peripheral devices 118 may include any type of peripheral device commonly found in a typical computing device, such as various input/output devices. For example, the peripheral devices 118 may include communication circuitry, display circuitry, various input buttons and switches, a keyboard, a mouse, speaker, microphone, and/or other peripheral devices.

The network interface controller 120 may be embodied as any device, circuit, or collection of devices and/or circuits capable of facilitating communications between the computing device 102 and the remote computing device 104 over the network 106. For example, the network interface controller 120 may be embodied as a separate peripheral card communicatively coupled to a motherboard of the computing device 102 or may be embodied as a circuit or collection of devices integrated on the motherboard. Additionally, the network interface controller 120 may be embodied as a single network interface controller device or circuit or as multiple network interface controller devices or circuits communicatively coupled together as discussed below. In some embodiments, the network interface controller 120 may include a dedicated memory 122 to store packets to facilitate the passing of packets between the various partitions of the computing device 102 as discussed below.

Similar to the computing device 102, the remote computing device 104 may be embodied as any type of computing device for communicating over the network 106 using network virtualization. For example, the computing device 102 may be embodied as a server, a server controller, a router, a switch, a networking device, a distributed computing system, a multiprocessor system, desktop computer, a consumer electronic device, a smart appliance, a laptop computer, a notebook computer, a tablet computer, a smart phone, a cellular phone, and/or any other computing device capable of network virtualization. The components, structure, and processes of the remote computing device 104 may be substantially similar to the corresponding components, structure, and processes described with regard to the computing device 102 and are not repeated herein for clarity of the description.

As discussed, the computing device 102 and the remote computing device 104 communicate with each other over the external network 106. The network 106 may be embodied as any number of various wired and/or wireless networks. For example, the network 106 may be embodied as, or otherwise include, a wired or wireless local area network (LAN), a wired or wireless wide area network (WAN), a cellular network, and/or a publicly-accessible, global network such as the Internet. As such, the network 106 may include any number of additional devices, such as additional computers, routers, and switches, to facilitate communications among the various devices of the system 100.

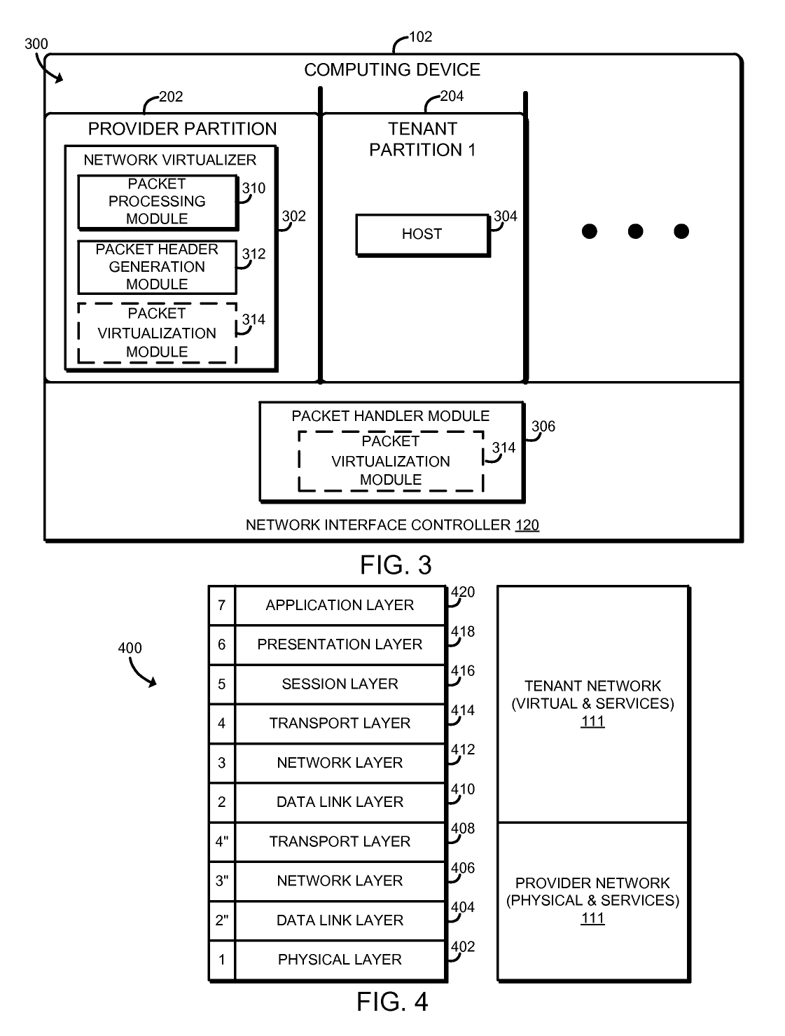

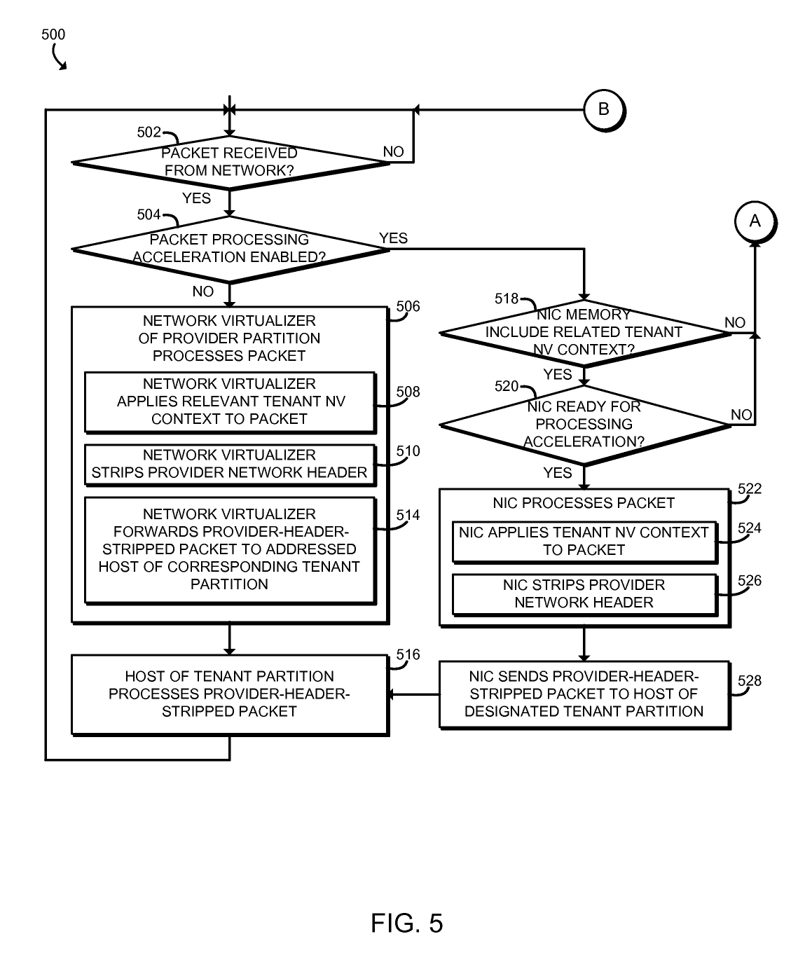

Referring now to FIG. 2, in the illustrative embodiment, the computing device 102 establishes a provider partition 202 and one or more tenant partitions 204. As discussed below, a network virtualizer is established in the provider partition 202 and one or more hosts (e.g., a virtual machine, operating system, application, etc.) is established in each tenant partition 204 (see, e.g., FIG. 3). The partitioning of the provider partition 202 and separate tenant partitions 204 provide an amount of isolation between those partitions. To do so, in some embodiments, a root hypervisor 210 may be established on the computing device 102 to isolate the provider partition 202 from the tenant partitions 204. The network virtualizer 302 (see FIG. 3) may execute on the root hypervisor, while separate hypervisors 212 and associated virtual machines 214 may be established in each tenant partition 204. In this way, each tenant partition 204 may be hypervisor-independent (i.e., each tenant partition 204 may execute a different hypervisor). Alternatively, one or more tenant partitions 204 may operate on native or bare metal I/O without the use of any hypervisor 212. Alternatively, in other embodiments, the computing device 102 may not utilize a root hypervisor 210 and, in such embodiments, the provider partition 202 and the tenant partitions 204 are managed by a corresponding hypervisor.

As discussed above, the network interface controller 120 includes multiple ports for communicating with the partitions 202, 204 and the network 106. In the illustrative embodiments, the network interface controller 120 includes a tenant-facing port 220 for each tenant partition 204 (which may be SR-IOV enabled), a provider-facing port 222, and a network-facing port 224. As illustrative shown in FIG. 2, a packet originating from a tenant partition 204 is received by the network interface controller 120 via the tenant-facing port 220, passed to the network virtualizer in the provider partition (which is implanted as a “bump in the wire”) via the provider-facing port 222, and subsequently transmitted across the network 106 via the network-facing port 224. Such passing of packets may be accomplished via use of direct memory access (DMA) with the memory 122 of the network interface controller 120. In this way, packet processing functions (e.g., encapsulation, de-capsulation, access control lists, etc.) may be performed, completely or partially, in the provider partition while packet movement functions are handled by the network interface controller 120 via the direct memory accesses.

Each of the tenant-facing ports 220 and the provider-facing port 222 may be embodied as a physical or virtual port. For example, in some embodiments, the network interface controller 120 may be embodied as a single dual-port network interface controller in which the physical ports are cascaded. In such embodiments, the tenant partition 204 may be coupled to a virtual tenant-facing port 220. The network interface controller 120 may pass packets from the virtual tenant-facing port 220 to a physical provider-facing port 222 and subsequently across the network 106 via a physical network-facing port 224. Alternatively, the network interface controller 120 may be embodied as a cascaded pair of dual port network interface controllers in which the tenant partition 204 is attached to a physical tenant-facing port 220, the provider partition 202 is attached to a physical provider-facing port 222, and the packets are transmitted from the computing device 102 via a physical network-facing port 224. In such embodiments, the physical tenant-facing port 220 and the physical provider-facing port 222 are connected back-to-back. Further, in some embodiments, the network interface controller 120 may be embodied as a multi-function network interface controller having three host-facing interfaces and a network-facing port with internal on-die fabric and shared resources.

Referring now to FIG. 3, the computing device 102 may establish an environment 300 during operation. The environment 300 includes a network virtualizer 302 established in the provider partition, a host 304 (e.g., a virtual machine, operating system, application, etc.) established in the tenant partition 204, and a packet handler module 306 established in the network interface controller 120. The network virtualizer 302 includes a packet processing module 310 and a packet header generation module 312. The network virtualizer 302 may also include a packet virtualization module 314. Alternatively, the packet virtualization module 314 may be included in the packet handler module 306 of the network interface controller 120. Each of the modules and components of the environment 300 may be embodied as firmware, software, hardware, and/or any combination thereof.

The various modules of the environment 300 may be embodied as hardware, firmware, software, or a combination thereof. For example the various modules, logic, and other components of the environment 300 may form a portion of, or otherwise be established by, the processor 110, the network interface controller 120, or other hardware components of the computing device 102. As such, in some embodiments, any one or more of the modules of the environment 300 may be embodied as a circuit or collection of electrical devices (e.g., a packet handler circuit, a network virtualizer circuit, etc.).

As discussed above, the network virtualizer 302 is configured to perform network virtualization functions for the computing device 102. To do so, the packet processing module 310 is configured to process packets to apply tenant context (e.g., access rules) to received and transmitted communications as discussed below. Additionally, the packet header generation module 312 is configured to generate a provider packet header for use in encapsulating outgoing packets (i.e., packets generated by a host 304 of a tenant partition 204). The packet virtualization module 314 is configured to process outgoing and incoming packets to enable the network virtualization. To do so, for example, the packet virtualization module 314 encapsulates outgoing packets using the generated provider packet header and strips any provider packet header from incoming packets.

The packet handler module 306 facilitates the movement of packets to, from, and/or between the tenant partitions 204 and the provider partition 202. To do so, as discussed above, the network interface controller 120 may utilize direct memory access to the local memory 122. In some embodiments, the packet handler module 306 includes the packet virtualization module 314 to further accelerate network virtualization functions. In such embodiments, the packet handler module 306 is responsible for encapsulating outgoing packets using the provider packet header received from the packet header generation module 312 of the network virtualizer 302 and de-capsulating incoming packets as discussed above. In either case, the packet handler module 306 may pass the incoming/outgoing packet, or a portion thereof, to the network virtualizer for further processing (e.g., packet or communication analysis).

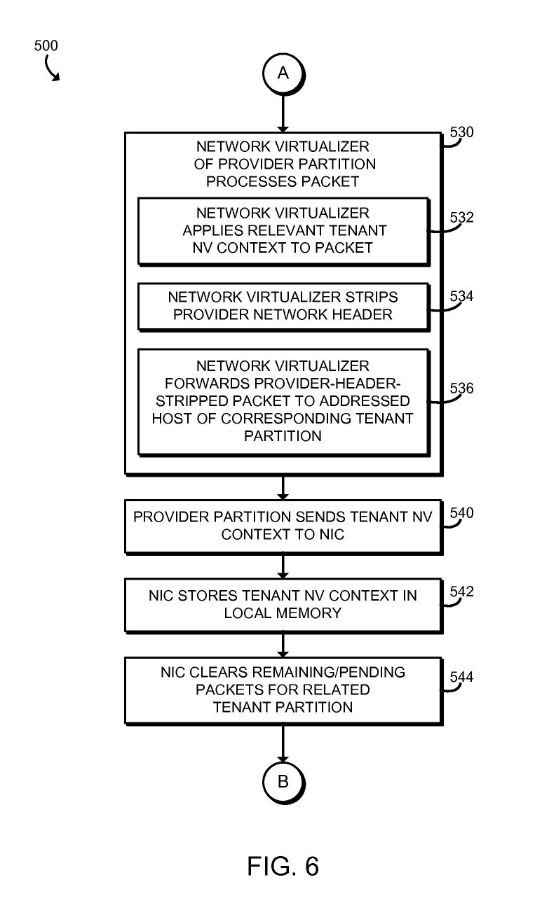

To facilitate the disclosed network virtualization, the computing device 102 may implement a network stack 400 as shown in FIG. 4. The network stack 400 is similar to a traditional network stack, except for the addition of layers 2″, 3″, and 4″, which correspond to the provider packet header. That is, as shown the tenant packet layers 2-7 are encapsulated by the provider packet layers 1-4″. Such configuration provides an amount of packet-based abstraction.

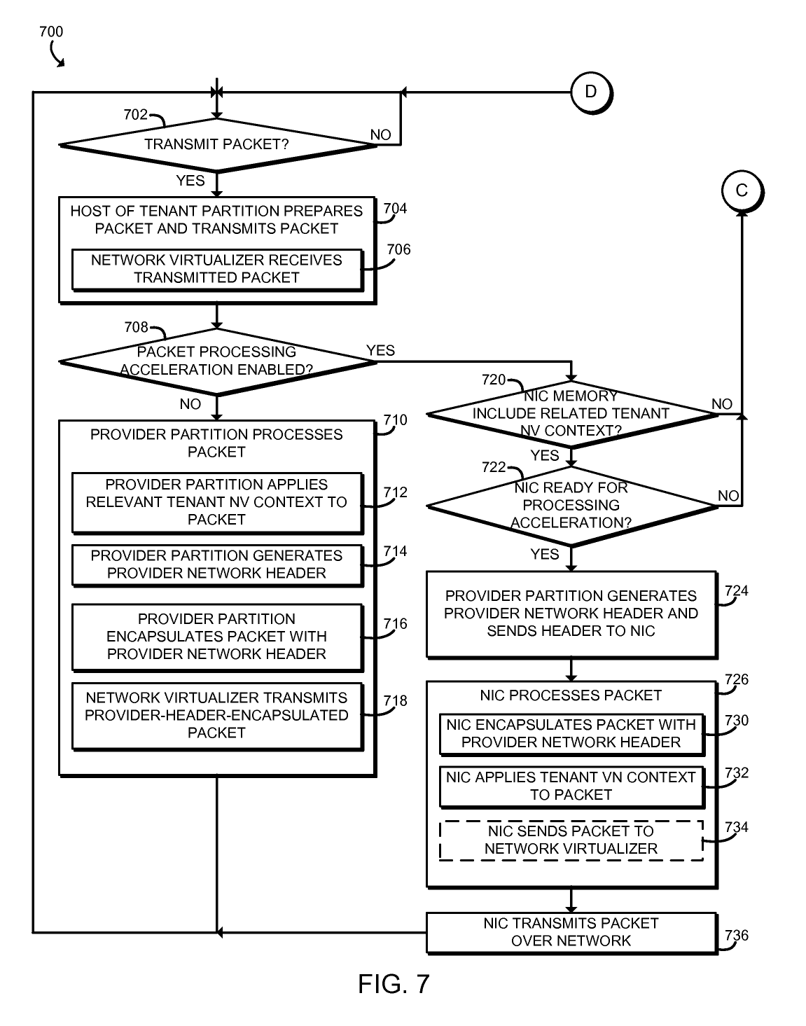

Referring now to FIGS. 5 and 6, in use, the computing device 102 may execute a method 500 for receiving packets from the network 106. The method 500 begins with block 502 in which the computing device 102 determines whether a packet has been received from the network 106. If so, the method 500 advances to block 504 in which the network interface controller 120 determines whether packet processing acceleration has been enabled. The packet processing acceleration may be enabled manually or automatically and may be indicated by a corresponding flag or indicator register, value, or memory location.

If packet processing acceleration is not enabled, the method 500 advances to block 506 in which the network virtualizer 302 of the provider partition 202 processes the packet. To do so, in block 508, the packet processing module 310 of the network virtualizer 302 applies any relevant tenant network virtualization context to the packet. For example, the packet processing module 310 may apply any appropriate networking rules or data processing functions required by the host 304 of the designated tenant partition 204. In block 510, the packet virtualization module 314 of the network virtualizer 302 strips any provider packet header from the received packet, and the network virtualizer 302 subsequently forwards the stripped packet to the destination host of the network packet of the corresponding tenant partition in block 514. To do so, the network virtualizer 302 sends the provider-header-stripped packet to the provider-facing port 222, and the host of the corresponding tenant partition receives the provider-header-stripped packet via the corresponding tenant-facing port 220. Subsequently, in block 516, the host of the corresponding tenant partition processes the received packet, and the method loops back to block 502 to await receipt of further packets.

Referring back to block 504, if packet processing acceleration is enabled, the method 500 advances to block 518 in which the network interface controller 120 determines whether the memory 122 of the network interface controller 120 includes the network virtualization context for the destination tenant partition 204 of the packet. If so, the method 500 advances to block 520 in which the network interface controller 120 determines whether the it is ready for packet processing acceleration. To do so, the network interface controller 120 determines whether there are any remaining or pending packets being processed by the network virtualizer for that particular tenant. That is, the network interface controller 120 ensures that packets are processed in the proper order and not provided to the host 304 in out-of-order sequence.

If the network interface controller 120 is ready for packet processing acceleration, the method 500 advances to block 522 in which the network interface controller 120 processes the received packet. For example, in block 524, the packet handler module 306 of the network interface controller 120 applies any relevant tenant network virtualization context stored in the memory 122 to the received packet. For example, the packet handler module 306 may apply any appropriate networking rules or data processing functions required by the host 304 of the designated tenant partition 204. In block 526, the packet virtualization module 314 of the network interface controller 120 strips any provider packet header from the received packet. The packet handler module 306 of the network interface controller 120 subsequently sends the provider-header-stripped packet to the host 304 of the designated tenant partition 204 via the corresponding tenant-facing port 220 in block 528, and the host 304 processes the received packet in block 520 as discussed above.

Referring back to blocks 518 and 520, if the memory 122 of the network interface controller 120 does not include the relevant network virtualization context or the network interface controller 120 is not otherwise ready for packet processing acceleration, the method 500 advances to block 530 (see FIG. 6). In block 530, the network virtualizer 302 processes the packet as discussed above in regard to block 508. For example, the packet processing module 310 of the network virtualizer 302 applies any relevant tenant network virtualization context to the packet in block 532 and the packet virtualization module 314 strips any provider packet header from the received packet in block 534. In block 536, the network virtualizer 302 sends the provider-header-stripped packet to the provider-facing port 222, and the host of the corresponding tenant partition receives the provider-header-stripped packet via the corresponding tenant-facing port 220.

In block 542, the network virtualizer 302 also sends the relevant tenant network virtualization context to the packet handler module 306 of the network interface controller 120, which is stored in the local memory 122 in block 544. The network virtualizer 302 may send the relevant tenant network virtualization context to the network interface controller 120 via the network-facing port 224 or the provider-facing port 222. Additionally, in block 546, the network interface controller 120 clears any remaining or pending packets for the related tenant partition to ensure the network interface controller 120 is ready for packet processing acceleration upon receipt of future packets. The method 500 subsequently loops back to block 502 in which the computing device 102 awaits additional packets to be received.

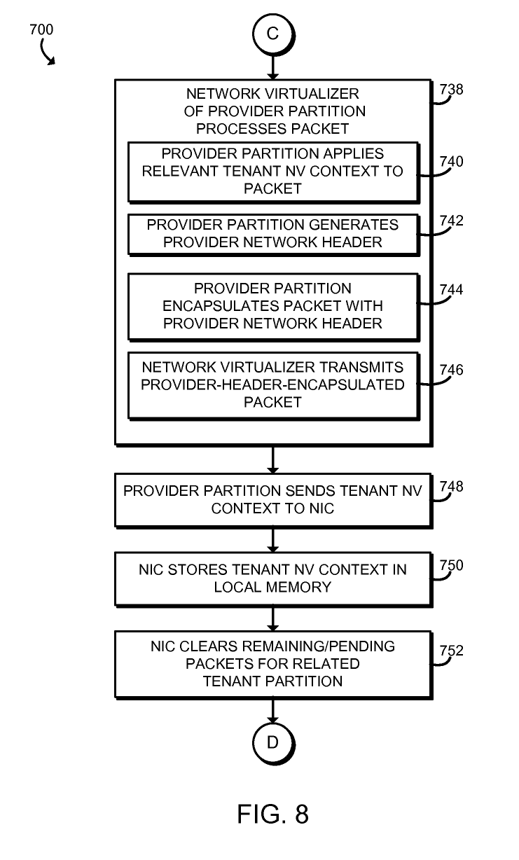

Referring now to FIGS. 7 and 8, in use, the computing device 102 may execute a method 700 for transmitting packets across the network 106. The method 700 begins with block 702 in which the computing device 102 determines whether a packet is to be transmitted. If so, the method 700 advances to block 504 in which the host 304 of the relevant tenant partition prepares the packet to be transmitted and transmits the packet via the tenant-facing port 220 (e.g., via direct memory access to the memory 122). Because the tenant-facing port 220 is communicatively connected to the provider-facing port 222 as discussed above, the transmitted packet is received by the network virtualizer 302 of the provider partition 202 via the provider-facing port 222 in block 706. In block 708, the network interface controller 120 determines whether packet processing acceleration has been enabled.

If packet processing acceleration is not enabled, the method 700 advances to block 710 in which the network virtualizer 302 processes the packet. For example, in block 712, the packet processing module 310 of the network virtualizer 302 applies any relevant tenant network virtualization context to the packet. In block 714, the packet header generation module 312 generates a provider packet header, and the packet virtualization module 314 encapsulates the packet using the generated provider packet header in block 716. Subsequently, in block 718, the network virtualizer 302 transmits the encapsulated packet across the network 106 to its destination address via the network-facing port 224.

Referring back to block 708, if packet processing acceleration is enabled, the method 700 advances to block 720 in which the network interface controller 120 determines whether the memory 122 of the network interface controller 120 includes the network virtualization context for the tenant partition 204 from which the packet originated. If so, the method 700 advances to block 722 in which the network interface controller 120 determines whether the network interface controller 120 is ready for packet processing acceleration. As discussed above, to do so, the network interface controller 120 may determine whether there are any remaining or pending packets being processed by the network virtualizer for that particular tenant.

If the network interface controller 120 is ready for packet processing acceleration, the method 700 advances to block 724 in which the packet header generation module 312 of the network virtualizer 302 generates the provider packet header and sends the provider packet header to the network interface controller 120 via either the network-facing port 224 or the provider-facing port 222 as discussed above. Subsequently, in block 726, the network interface controller 120 processes the packet to be transmitted. To do so, the packet virtualization module 314 of the network interface controller 120 encapsulates the packet using the received provider packet header in block 728. In block 730, the packet handler module 306 applies any relevant tenant network virtualization context to the packet. In some embodiments, the network interface controller 120 may also send the packet, or a portion thereof, to the network virtualizer 302 of the provider partition 202 for further processing and/or analysis in block 734. Regardless, in block 736, the network interface controller 120 transmits the encapsulated packet across the network 106 via the network-facing port 224 as discussed above.

Referring back to blocks 720 and 722, if the memory 122 of the network interface controller 120 does not include the relevant network virtualization context or the network interface controller 120 is not otherwise ready for packet processing acceleration, the method 700 advances to block 738 (see FIG. 8). In block 738, the network virtualizer 302 processes the packet as discussed above in regard to block 710. For example, the packet processing module 310 applies any relevant tenant network virtualization context to the packet in block 740, the packet header generation module 312 generates a provider packet header in block 742, and the packet virtualization module 314 encapsulates the packet using the generated provider packet header in block 744. Subsequently, in block 746, the network virtualizer 302 transmits the encapsulated packet across the network 106 to its destination address via the network-facing port 224.

In block 748, the network virtualizer 302 sends the relevant tenant network virtualization context to the packet handler module 306 of the network interface controller 120, which is stored in the local memory 122 in block 750. As discussed above, the network virtualizer 302 may send the relevant tenant network virtualization context to the network interface controller 120 via the network-facing port 224 or the provider-facing port 222. Additionally, in block 752, network interface controller 120 clears any remaining or pending packets for the related tenant partition from the network virtualizer in block 552 to ensure the network interface controller 120 is ready for packet processing acceleration for future packet transmissions. The method 700 subsequently loops back to block 702 in which the computing device 102 awaits to transmit additional packets.

### EXAMPLES

Illustrative examples of the devices, systems, and methods disclosed herein are provided below. An embodiment of the devices, systems, and methods may include any one or more, and any combination of, the examples described below.

Example 1 includes a computing device for accelerated network virtualization, the computing device comprising a host established on a tenant partition of the computing device; a network virtualizer established in a provider partition of the computing device different from the tenant partition, the network virtualizer to generate a provider header; and a network interface controller having a first port to facilitate communication with the host of the tenant partition, a second port to facilitate communication with network virtualizer of the provider partition, and a third port to facilitate communication with a network external to the computing device, wherein the network interface controller includes a packet handler module to pass packets between the tenant partition and the provider partition and transmit packets encapsulated with the provider header across the network via the third port.

Example 2 includes the subject matter of Example 1, and wherein the network interface controller is to receive a packet from the host of the tenant partition via the first port and send the packet to the network virtualizer of the provider portion via the second port, and the network virtualizer is to (i) generate a provider header for the packet, (ii) encapsulate the packet using the provider header, and (iii) send, via the third port of the network interface controller, the encapsulated packet to the network.

Example 3 includes the subject matter of any of Examples 1 and 2, and wherein the network virtualizer is further to determine a host network virtualization context based on the packet; and apply the host network virtualization context to the packet.

Example 4 includes the subject matter of any of Examples 1-3, and wherein the network virtualizer is to generate a provider header for the packet and pass the provider header to the network interface controller via the second or third port, and the network interface controller is to (i) receive a packet from the host of the tenant partition via the first port, (ii) receive the provider header from the network virtualizer via the second or third port, (iii) encapsulate the packet with the provider header, and (iv) transmit the encapsulated packet across the network via the third port.

Example 5 includes the subject matter of any of Examples 1-4, and wherein the network interface controller is further to determine a host network virtualization context based on the packet; and apply the host network virtualization context to the packet.

Example 6 includes the subject matter of any of Examples 1-5, and wherein the network interface controller is further to receive a packet from the host of the tenant partition via the first port; determine whether a network virtualization context associated with the host is stored in a local memory of the network interface controller; and in response to a determination that the network virtualization context associated with the host is stored in the local memory: (i) retrieve the network virtualization context associated with the host from the local memory, (ii) apply the network virtualization context to the packet, (iii) receive a provider header from the network virtualizer, and (iv) encapsulate the packet with the provider header.

Example 7 includes the subject matter of any of Examples 1-6, and wherein the network interface controller is to (i) receive a packet from the host of the tenant partition via the first port, (ii) determine whether a network virtualization context associated with the host is stored in a local memory of the network interface controller, and (iii) send the packet to the network virtualizer of the provider partition via the second port in response to a determination that the network virtualization context associated with the host is not stored in the local memory, the network virtualizer is to (i) determine a host network virtualization context based on the packet, (ii) apply the host network virtualization context to the packet, (iii) encapsulate the packet with the provider header, (iii) send, via the second or third port, the host network virtualization context to the network interface controller, and (iv) send, via the third port of the network interface controller, the encapsulated packet to the network.

Example 8 includes the subject matter of any of Examples 1-7, and wherein the network interface controller is further to store the host network virtualization context in the local memory of the network interface controller.

Example 9 includes the subject matter of any of Examples 1-8, and wherein the network interface controller is further to receive, via the first port, another packet generated by the host of the tenant partition; retrieve the host network virtualization context stored in the local memory; and apply the host network virtualization context to the packet.

Example 10 includes the subject matter of any of Examples 1-9, and wherein the network interface controller is further to receive the provider header from the network virtualizer via the second port and encapsulate the packet with the provider header.

Example 11 includes the subject matter of any of Examples 1-10, and wherein the network interface controller is further to receive a packet from the host of the tenant partition via the first port, receive, from the network virtualizer, a host network virtualization context associated with the host, and apply the host network virtualization context to the packet.

Example 12 includes the subject matter of any of Examples 1-11, and wherein the network virtualizer is to receive, via the third port of the network interface controller, a packet from the network, to strip a provider header of the received packet, and send the stripped received packet to the host of the tenant partition via the second port, wherein the network interface controller is to pass the stripped received packet from the second port to the first port.

Example 13 includes the subject matter of any of Examples 1-12, and wherein the network virtualizer is further to determine host network virtualization context based on the packet and apply the host network virtualization context to the packet.

Example 14 includes the subject matter of any of Examples 1-13, and wherein the network interface controller is to determine, subsequent to receipt of the packet, whether a network virtualization context associated with the host is stored in a local memory of the network interface controller; and in response to determining that the network virtualization context associated with the host is stored in the local memory: retrieve the network virtualization context associated with the host from the local memory and apply the network virtualization context to the another packet.

Example 15 includes the subject matter of any of Examples 1-14, and wherein the network interface controller is to determine whether a network virtualization context associated with the host is stored in a local memory of the network interface controller and send the packet to the network virtualizer of the provider partition via the third port in response to a determination that the network virtualization context associated with the host is not stored in the local memory, the network virtualizer is to (i) determine a host network virtualization context based on the packet, (ii) apply the host network virtualization context to the packet, and (iii) send, via the second port, the host network virtualization context to the network interface controller.

Example 16 includes the subject matter of any of Examples 1-15, and wherein the network interface controller is to store the host network virtualization context in the local memory of the network interface controller.

Example 17 includes the subject matter of any of Examples 1-16, and wherein the network interface controller is to receive an another packet from the network via the third port, retrieve the host network virtualization context stored in the local memory, and apply the host network virtualization context to the another packet.

Example 18 includes the subject matter of any of Examples 1-17, and wherein the network interface controller is further to strip a provider header of the another packet and send, the stripped another packet to the host of the tenant partition via the first port.

Example 19 includes the subject matter of any of Examples 1-18, and wherein the network interface controller is further to receive a packet from the network via the third port, strip a provider header of the received packet, and send the stripped packet to the host of the tenant partition via the first port.

Example 20 includes the subject matter of any of Examples 1-19, and wherein the network interface controller is further to determine a host network virtualization context based on the another packet and apply the host network virtualization context to the another packet.

Example 21 includes a method for accelerated network virtualization, the method comprising generating, by a host of a tenant partition of a computing device, a packet for transmission from the computing device; generating, by a network virtualizer established in a provider partition of the computing device different from the tenant partition, a provider header for the packet; receiving, by a first port of a network interface controller of the computing device, the packet from the host of the tenant partition; communicating, by a second port of the network interface controller, with the network virtualizer to encapsulate the packet with the provide header; and transmitting, by a third port of the network interface controller, the packet encapsulated with the provider header across a network external to the computing device.

Example 22 includes the subject matter of Example 21, and wherein communicating with the network virtualizer comprises sending, from the network interface controller, the packet received from the host of the tenant partition to the network virtualizer of the provider partition via the second port; encapsulating, by the network virtualizer, the packet with the provider header; and sending, by the network virtualizer, the encapsulated packet to the network via the third port of the network interface controller.

Example 23 includes the subject matter of any of Examples 21 and 22, and further including determining, by the network virtualizer, a host network virtualization context based on the packet; and applying, by the network virtualizer, the host network virtualization context to the packet.

Example 24 includes the subject matter of any of Examples 21-23, and wherein communicating with the network virtualizer comprises receiving, by the network interface controller, the provider header from the network virtualizer via the second or third port; and encapsulating, by the network interface controller, the packet with the provider header.

Example 25 includes the subject matter of any of Examples 21-24, and further including determining, by the network interface controller, a host network virtualization context based on the packet; and applying, by the network interface controller, the host network virtualization context to the packet.

Example 26 includes the subject matter of any of Examples 21-25, and further including determining, by the network interface controller, whether a network virtualization context associated with the host is stored in a local memory of the network interface controller; and in response to determining that the network virtualization context associated with the host is stored in the local memory (i) retrieving, by the network interface controller, the network virtualization context associated with the host from the local memory, (ii) applying, by the network interface controller, the network virtualization context to the packet, (iii) receiving, by the network interface controller, the provider header from the network virtualizer, and (iv) encapsulating, by the network interface controller, the packet with the provider header.

Example 27 includes the subject matter of any of Examples 21-26, and further including determining, by the network interface controller, whether a network virtualization context associated with the host is stored in a local memory of the network interface controller; and in response to determining that the network virtualization context associated with the host is not stored in the local memory (i) sending, from the network interface controller, the packet to the network virtualizer of the provider partition via the second port, (ii) determining, by the network virtualizer, a host network virtualization context based on the packet (ii) applying, by the network virtualizer, the host network virtualization context to the packet, (iii) encapsulating, by the network virtualizer, the packet with the provider header, (iv) receiving, by the network interface controller and from the network virtualizer, the host network virtualization context.

Example 28 includes the subject matter of any of Examples 21-27, and further including storing the host network virtualization context in the local memory of the network interface controller.

Example 29 includes the subject matter of any of Examples 21-28, and further including receiving, by the first port of the network interface controller, another packet generated by the host of the tenant partition; retrieving, by the network interface controller, the host network virtualization context stored in the local memory; and applying, by the network interface controller, the host network virtualization context to the packet.

Example 30 includes the subject matter of any of Examples 21-29, and further including receiving, by the network interface controller, the provider header from the network virtualizer via the second port, and encapsulating, by the network interface controller, the packet with the provider header.

Example 31 includes the subject matter of any of Examples 21-30, and further including receiving, by the network interface controller and from the network virtualizer, a host network virtualization context associated with the host, and applying, by the network interface controller, the host network virtualization context to the packet.

Example 32 includes the subject matter of any of Examples 21-31, and further including receiving, by the network virtualizer, another packet from the network via the third port; stripping, by the network virtualizer, a provider header of the another packet; sending, by the network virtualizer, the stripped another packet to host of the tenant partition via the second port, and passing, by the network interface controller, the stripped received packet from the second port to the third port.

Example 33 includes the subject matter of any of Examples 21-32, and further including determining, by the network virtualizer, a host network virtualization context based on the another packet; and applying, by the network virtualizer, the host network virtualization context to the another packet.

Example 34 includes the subject matter of any of Examples 21-33, and further including determining, by the network interface controller and subsequent to receiving the another packet, whether a network virtualization context associated with the host is stored in a local memory of the network interface controller; and in response to determining that the network virtualization context associated with the host is stored in the local memory (i) retrieving, by the network interface controller, the network virtualization context associated with the host from the local memory, and (ii) applying, by the network interface controller, the network virtualization context to the another packet.

Example 35 includes the subject matter of any of Examples 21-34, and further including determining, by the network interface controller, whether a network virtualization context associated with the host is stored in a local memory of the network interface controller; and in response to determining that the network virtualization context associated with the host is not stored in the local memory (i) sending, from the network interface controller, the another packet to the network virtualizer of the provider partition via the third port, (ii) determining, by the network virtualizer, a host network virtualization context based on the another packet (ii) applying, by the network virtualizer, the host network virtualization context to the another packet, and (v) receiving, by the network interface controller and from the network virtualizer, the host network virtualization context.

Example 36 includes the subject matter of any of Examples 21-35, and further including storing the host network virtualization context in the local memory of the network interface controller.

Example 37 includes the subject matter of any of Examples 21-36, and further including receiving, by the network interface controller, an additional packet from the network via the third port; retrieving, by the network interface controller, the host network virtualization context stored in the local memory; and applying, by the network interface controller, the host network virtualization context to the additional packet.

Example 38 includes the subject matter of any of Examples 21-37, and further including stripping, by the network interface controller, a provider header of the additional packet; and sending, by the network interface controller, the stripped additional packet to the host of the tenant partition via the first port.

Example 39 includes the subject matter of any of Examples 21-38, and further including receiving, by the network interface controller, another packet from the network via the third port; stripping, by the network interface controller, a provider header of the received another packet; and sending, by the network interface controller, the stripped another packet to the host of the tenant partition via the first port.

Example 40 includes the subject matter of any of Examples 21-39, and further including determining, by the network interface controller, a host network virtualization context based on the another packet; and applying, by the network interface controller, the host network virtualization context to the another packet.

Example 41 includes one or more machine-readable storage media comprising a plurality of instructions stored thereon that, in response to execution, cause a computing device to perform the method of any of Examples 21-40.

Example 42 includes a computing device for accelerated network virtualization, the computing device comprising means for generating a packet for transmission from the computing device; means for generating a provider header for the packet; means for receiving the packet from the host of the tenant partition; means for communicating with the network virtualizer to encapsulate the packet with the provide header; and means for transmitting the packet encapsulated with the provider header across a network external to the computing device.

Example 43 includes the subject matter of Example 42, and wherein the means for communicating with the network virtualizer comprises means for sending the packet received from the host of the tenant partition to the network virtualizer of the provider partition via the second port; means for encapsulating the packet with the provider header; and means for sending the encapsulated packet to the network via the third port of the network interface controller.

Example 44 includes the subject matter of any of Examples 42 and 43, and further including means for determining a host network virtualization context based on the packet; and means for applying the host network virtualization context to the packet.

Example 45 includes the subject matter of any of Examples 42-44, and wherein the means for communicating with the network virtualizer comprises means for receiving the provider header from the network virtualizer via the second or third port; and means for encapsulating the packet with the provider header.

Example 46 includes the subject matter of any of Examples 42-45, and further including means for determining a host network virtualization context based on the packet; and means for applying the host network virtualization context to the packet.

Example 47 includes the subject matter of any of Examples 42-46, and further including means for determining whether a network virtualization context associated with the host is stored in a local memory of the network interface controller; and means for, in response to determining that the network virtualization context associated with the host is stored in the local memory, (i) retrieving the network virtualization context associated with the host from the local memory, (ii) applying the network virtualization context to the packet, (iii) receiving the provider header from the network virtualizer, and (iv) encapsulating the packet with the provider header.

Example 48 includes the subject matter of any of Examples 42-47, and further including means for determining whether a network virtualization context associated with the host is stored in a local memory of the network interface controller; and means for, in response to determining that the network virtualization context associated with the host is not stored in the local memory, (i) sending the packet to the network virtualizer of the provider partition via the second port, (ii) determining a host network virtualization context based on the packet, (ii) applying the host network virtualization context to the packet, (iii) encapsulating the packet with the provider header, (iv) receiving the host network virtualization context.

Example 49 includes the subject matter of any of Examples 42-48, and further including means for storing the host network virtualization context in the local memory of the network interface controller.

Example 50 includes the subject matter of any of Examples 42-49, and further including means for receiving another packet generated by the host of the tenant partition; means for retrieving the host network virtualization context stored in the local memory; and means for applying the host network virtualization context to the packet.

Example 51 includes the subject matter of any of Examples 42-50, and further including means for receiving the provider header from the network virtualizer via the second port, and means for encapsulating the packet with the provider header.

Example 52 includes the subject matter of any of Examples 42-51, and further including means for receiving a host network virtualization context associated with the host, and means for applying, the host network virtualization context to the packet.

Example 53 includes the subject matter of any of Examples 42-52, and further including means for receiving another packet from the network via the third port; means for stripping a provider header of the another packet; means for sending the stripped another packet to host of the tenant partition via the second port, and means for passing the stripped received packet from the second port to the third port.

Example 54 includes the subject matter of any of Examples 42-53, and further including means for determining a host network virtualization context based on the another packet; and means for applying the host network virtualization context to the another packet.

Example 55 includes the subject matter of any of Examples 42-54, and further including means for determining, subsequent to receiving the another packet, whether a network virtualization context associated with the host is stored in a local memory of the network interface controller; and means for, in response to determining that the network virtualization context associated with the host is stored in the local memory, (i) retrieving the network virtualization context associated with the host from the local memory and (ii) applying the network virtualization context to the another packet.

Example 56 includes the subject matter of any of Examples 42-55, and further including means for determining, by the network interface controller, whether a network virtualization context associated with the host is stored in a local memory of the network interface controller; and means for, in response to determining that the network virtualization context associated with the host is not stored in the local memory, (i) sending the another packet to the network virtualizer of the provider partition via the third port, (ii) determining a host network virtualization context based on the another packet, (ii) applying the host network virtualization context to the another packet, and (v) receiving the host network virtualization context.

Example 57 includes the subject matter of any of Examples 42-56, and further including means for storing the host network virtualization context in the local memory of the network interface controller.

Example 58 includes the subject matter of any of Examples 42-57, and further including means for receiving an additional packet from the network via the third port; means for retrieving the host network virtualization context stored in the local memory; and means for applying the host network virtualization context to the additional packet.

Example 59 includes the subject matter of any of Examples 42-58, and further including means for stripping a provider header of the additional packet; and means for sending the stripped additional packet to the host of the tenant partition via the first port.

Example 60 includes the subject matter of any of Examples 42-59, and further including means for receiving another packet from the network via the third port; means for stripping a provider header of the received another packet; and means for sending the stripped another packet to the host of the tenant partition via the first port.

Example 61 includes the subject matter of any of Examples 42-60, and further including means for determining a host network virtualization context based on the another packet; and means for applying the host network virtualization context to the another packet.

1. A computing device for accelerated network virtualization, the computing device comprising:
a host established on a tenant partition of the computing device;
a network virtualizer established in a provider partition of the computing device different from the tenant partition, the network virtualizer to generate a provider header; and
a network interface controller having a first port to facilitate communication with the host of the tenant partition, a second port to facilitate communication with network virtualizer of the provider partition, and a third port to facilitate communication with a network external to the computing device,
wherein the network interface controller includes a packet handler module to pass packets between the tenant partition and the provider partition and transmit packets encapsulated with the provider header across the network via the third port.

2. The computing device of claim 1, wherein:
the network interface controller is to receive a packet from the host of the tenant partition via the first port and send the packet to the network virtualizer of the provider portion via the second port, and
the network virtualizer is to (i) generate a provider header for the packet, (ii) encapsulate the packet using the provider header, and (iii) send, via the third port of the network interface controller, the encapsulated packet to the network.

3. The computing device of claim 1, wherein:
the network virtualizer is to generate a provider header for the packet and pass the provider header to the network interface controller via the second or third port, and
the network interface controller is to (i) receive a packet from the host of the tenant partition via the first port, (ii) receive the provider header from the network virtualizer via the second or third port, (iii) encapsulate the packet with the provider header, and (iv) transmit the encapsulated packet across the network via the third port.

4. The computing device of claim 3, wherein the network interface controller is further to:
determine a host network virtualization context based on the packet; and
apply the host network virtualization context to the packet.

5. The computing device of claim 1, wherein the network interface controller is further to:
receive a packet from the host of the tenant partition via the first port;
determine whether a network virtualization context associated with the host is stored in a local memory of the network interface controller; and
in response to a determination that the network virtualization context associated with the host is stored in the local memory: (i) retrieve the network virtualization context associated with the host from the local memory, (ii) apply the network virtualization context to the packet, (iii) receive a provider header from the network virtualizer, and (iv) encapsulate the packet with the provider header.

6. The computing device of claim 1, wherein:
the network interface controller is to (i) receive a packet from the host of the tenant partition via the first port, (ii) determine whether a network virtualization context associated with the host is stored in a local memory of the network interface controller, and (iii) send the packet to the network virtualizer of the provider partition via the second port in response to a determination that the network virtualization context associated with the host is not stored in the local memory,
the network virtualizer is to (i) determine a host network virtualization context based on the packet, (ii) apply the host network virtualization context to the packet, (iii) encapsulate the packet with the provider header, (iii) send, via the second or third port, the host network virtualization context to the network interface controller, and (iv) send, via the third port of the network interface controller, the encapsulated packet to the network.

7. The computing device of claim 1, wherein:
the network virtualizer is to receive, via the third port of the network interface controller, a packet from the network, to strip a provider header of the received packet, and send the stripped received packet to the host of the tenant partition via the second port,
wherein the network interface controller is to pass the stripped received packet from the second port to the first port.

8. The computing device of claim 7, wherein the network interface controller is to determine, subsequent to receipt of the packet, whether a network virtualization context associated with the host is stored in a local memory of the network interface controller; and
in response to determining that the network virtualization context associated with the host is stored in the local memory: retrieve the network virtualization context associated with the host from the local memory and apply the network virtualization context to the another packet.

9. The computing device of claim 7, wherein:
the network interface controller is to determine whether a network virtualization context associated with the host is stored in a local memory of the network interface controller and send the packet to the network virtualizer of the provider partition via the third port in response to a determination that the network virtualization context associated with the host is not stored in the local memory,
the network virtualizer is to (i) determine a host network virtualization context based on the packet, (ii) apply the host network virtualization context to the packet, and (iii) send, via the second port, the host network virtualization context to the network interface controller.

10. One or more machine-readable storage media comprising a plurality of instructions stored thereon that, in response to execution, cause a computing device to:
generate, by a host of a tenant partition of a computing device, a packet for transmission from the computing device;
generate, by a network virtualizer established in a provider partition of the computing device different from the tenant partition, a provider header for the packet;
receive, by a first port of a network interface controller of the computing device, the packet from the host of the tenant partition;
communicate, by a second port of the network interface controller, with the network virtualizer to encapsulate the packet with the provide header; and
transmit, by a third port of the network interface controller, the packet encapsulated with the provider header across a network external to the computing device.

11. The one or more machine-readable storage media of claim 10, wherein to communicate with the network virtualizer comprises to:
send, from the network interface controller, the packet received from the host of the tenant partition to the network virtualizer of the provider partition via the second port;
encapsulate, by the network virtualizer, the packet with the provider header; and
send, by the network virtualizer, the encapsulated packet to the network via the third port of the network interface controller.

12. The one or more machine-readable storage media of claim 11, wherein the plurality of instructions further cause the computing device to:
determine, by the network virtualizer, a host network virtualization context based on the packet; and
apply, by the network virtualizer, the host network virtualization context to the packet.

13. The one or more machine-readable storage media of claim 10, wherein to communicate with the network virtualizer comprises to:
receive, by the network interface controller, the provider header from the network virtualizer via the second or third port; and
encapsulate, by the network interface controller, the packet with the provider header.

14. The one or more machine-readable storage media of claim 10, wherein the plurality of instructions further cause the computing device to:
determine, by the network interface controller, whether a network virtualization context associated with the host is stored in a local memory of the network interface controller; and
in response to determining that the network virtualization context associated with the host is stored in the local memory, to:
(i) retrieve, by the network interface controller, the network virtualization context associated with the host from the local memory,
(ii) apply, by the network interface controller, the network virtualization context to the packet,
(iii) receive, by the network interface controller, the provider header from the network virtualizer, and
(iv) encapsulate, by the network interface controller, the packet with the provider header.

15. The one or more machine-readable storage media of claim 10, wherein the plurality of instructions further cause the computing device to:
determine, by the network interface controller, whether a network virtualization context associated with the host is stored in a local memory of the network interface controller; and
in response to determining that the network virtualization context associated with the host is not stored in the local memory, to:
(i) send, from the network interface controller, the packet to the network virtualizer of the provider partition via the second port,
(ii) determine, by the network virtualizer, a host network virtualization context based on the packet
(ii) apply, by the network virtualizer, the host network virtualization context to the packet,
(iii) encapsulate, by the network virtualizer, the packet with the provider header,
(iv) receive, by the network interface controller and from the network virtualizer, the host network virtualization context.

16. The one or more machine-readable storage media of claim 10, wherein the plurality of instructions further cause the computing device to:
receive, by the network virtualizer, another packet from the network via the third port;
strip, by the network virtualizer, a provider header of the another packet;
send, by the network virtualizer, the stripped another packet to host of the tenant partition via the second port, and
pass, by the network interface controller, the stripped received packet from the second port to the third port.

17. The one or more machine-readable storage media of claim 10, wherein the plurality of instructions further cause the computing device to:
determine, by the network interface controller and subsequent to receiving the another packet, whether a network virtualization context associated with the host is stored in a local memory of the network interface controller; and
in response to determining that the network virtualization context associated with the host is stored in the local memory, to:
(i) retrieve, by the network interface controller, the network virtualization context associated with the host from the local memory, and
(ii) apply, by the network interface controller, the network virtualization context to the another packet.

18. A method for accelerated network virtualization, the method comprising:
generating, by a host of a tenant partition of a computing device, a packet for transmission from the computing device;
generating, by a network virtualizer established in a provider partition of the computing device different from the tenant partition, a provider header for the packet;
receiving, by a first port of a network interface controller of the computing device, the packet from the host of the tenant partition;
communicating, by a second port of the network interface controller, with the network virtualizer to encapsulate the packet with the provide header; and
transmitting, by a third port of the network interface controller, the packet encapsulated with the provider header across a network external to the computing device.

19. The method of claim 18, wherein communicating with the network virtualizer comprises:
sending, from the network interface controller, the packet received from the host of the tenant partition to the network virtualizer of the provider partition via the second port;
encapsulating, by the network virtualizer, the packet with the provider header; and
sending, by the network virtualizer, the encapsulated packet to the network via the third port of the network interface controller.

20. The method of claim 19, further comprising:
determining, by the network virtualizer, a host network virtualization context based on the packet; and
applying, by the network virtualizer, the host network virtualization context to the packet.

21. The method of claim 18, wherein communicating with the network virtualizer comprises:
receiving, by the network interface controller, the provider header from the network virtualizer via the second or third port; and
encapsulating, by the network interface controller, the packet with the provider header.

22. The method of claim 18, further comprising:
determining, by the network interface controller, whether a network virtualization context associated with the host is stored in a local memory of the network interface controller; and
in response to determining that the network virtualization context associated with the host is stored in the local memory:
(i) retrieving, by the network interface controller, the network virtualization context associated with the host from the local memory,
(ii) applying, by the network interface controller, the network virtualization context to the packet,
(iii) receiving, by the network interface controller, the provider header from the network virtualizer, and
(iv) encapsulating, by the network interface controller, the packet with the provider header.

23. The method of claim 18, further comprising:
determining, by the network interface controller, whether a network virtualization context associated with the host is stored in a local memory of the network interface controller; and
in response to determining that the network virtualization context associated with the host is not stored in the local memory:
(i) sending, from the network interface controller, the packet to the network virtualizer of the provider partition via the second port,
(ii) determining, by the network virtualizer, a host network virtualization context based on the packet
(ii) applying, by the network virtualizer, the host network virtualization context to the packet,
(iii) encapsulating, by the network virtualizer, the packet with the provider header,
(iv) receiving, by the network interface controller and from the network virtualizer, the host network virtualization context.

24. The method of claim 18, further comprising:
receiving, by the network virtualizer, another packet from the network via the third port;
stripping, by the network virtualizer, a provider header of the another packet;
sending, by the network virtualizer, the stripped another packet to host of the tenant partition via the second port, and
passing, by the network interface controller, the stripped received packet from the second port to the third port.

25. The method of claim 24, further comprising:
determining, by the network interface controller and subsequent to receiving the another packet, whether a network virtualization context associated with the host is stored in a local memory of the network interface controller; and
in response to determining that the network virtualization context associated with the host is stored in the local memory:
(i) retrieving, by the network interface controller, the network virtualization context associated with the host from the local memory, and
(ii) applying, by the network interface controller, the network virtualization context to the another packet.
